(19) United States
(12) Patent Application Publication
(10) Pub. No.: US 2026/0204579 A1
(43) Pub. Date: Jul. 16, 2026

(54) MULTILAYER BATTERY ELECTRODE ARCHITECTURE

(71) Applicant: UNIVERSITY OF SOUTH CAROLINA, COLUMBIA, SC (US)

(72) Inventors: GOLAREH JALILVAND, IRMO, SC (US); AVINASH RAULO, COLUMBIA, SC (US)

(21) Appl. No.: 19/425,098

(22) Filed: Dec. 18, 2025

Related U.S. Application Data
(60) Provisional application No. 63/735,497, filed on Dec. 18, 2024.

(51) Int. Cl. H01M 4/62; H01M 4/02; H01M 4/04; H01M 4/136; H01M 4/36; H01M 4/58

(52) U.S. Cl. CPC H01M 4/623; H01M 4/0404; H01M 4/0435; H01M 4/136; H01M 4/366; H01M 4/58; H01M 2004/021

(57) ABSTRACT

The present disclosure is generally directed toward multilayer electrode architectures, methods of manufacture thereof, and batteries made therefrom. In some embodiments, the multilayer electrode architecture may be formed by alternating deposition of different electrode slurries which comprise compositionally distinct binders. Generally, benefits obtained by the presently described multilayer electrodes are increased loading of electrode active material while maintaining good cycle performance and durability.

### REFERENCE TO RELATED APPLICATIONS

This application claims priority to Provisional Application No. 63/735,497 having a filing date of Dec. 18, 2024, which is incorporated by reference herein.

### BACKGROUND

Various materials are promising alternatives to presently utilized electrodes in lithium-ion batteries. For instance sulfur, among other materials, is a promising candidate for next-generation cathodes in lithium battery systems, and lithium-sulfur (Li—S) batteries are one of the promising alternatives for current lithium-ion battery (LIB) technology due to their superior specific energy density, which can satisfy the emerging needs of advanced energy storage applications such as electric vehicles and grid-scale energy storage and delivery. However, achieving this high specific energy density using currently available battery chemistries can be difficult in view of the high areal loadings of electrode active material which are required. For instance, modern devices may require an areal loading of electrode active material of greater than four milligrams per centimeter of electrode. However, when such electrodes have been formed, batteries made therefrom have suffered from decreased cyclability, increased resistance and decreased discharge rates.

As such, there is a need in the art for multilayer battery electrodes and methods for forming electrodes having increased electrode active material areal loadings sufficient to supply the requisite energy density for modern applications.

### SUMMARY

According to embodiments of the present disclosure, disclosed herein are multilayer electrodes, batteries made therefrom and methods of manufacture thereof.

For instance, the present disclosure describes a multilayer electrode comprising a current collector, an electrode active stack disposed on the current collector, the electrode active stack comprising a first electrode active layer disposed adjacent to the current collector and a second electrode active layer disposed adjacent to the first electrode active layer. The multilayer electrode further comprises a first and a second binder dispersed in the first electrode active layer and a second binder dispersed in the second electrode active layer.

Furthermore, the present disclosure details a battery comprising an anode, electrolyte, separator and cathode, wherein the anode or cathode comprise an electrode active stack disposed on a current collector, the electrode active stack comprising a first electrode active layer disposed adjacent to the current collector and a second electrode active layer disposed adjacent to the first electrode layer. The battery further comprises a first binder dispersed in the first electrode active layer and a second binder dispersed in the second electrode active layer.

As stated above, described herein are methods for forming multilayer electrodes. The method generally comprises the steps of depositing a first electrode slurry on a current collector and depositing a second electrode slurry on the first electrode slurry, wherein the first electrode slurry comprises a first binder and the second electrode slurry comprises a second binder.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIGS. 1A-1C are diagrams showing single layer (FIGS. 1A-1B) and multilayer (FIG. 1C) electrodes as described herein;

FIGS. 2A-2B are diagrams showing multilayer electrodes as described herein;

FIGS. 3A-3C are micrograms of CBAD-Sprayed electrodes with PVDF-based binders comprising 65 wt. % sulfur, 25 wt. % carbon and 10 wt. % PVDF with areal sulfur loadings of 1.1-1.4 mg cm⁻² (FIG. 3A), 1.9-2.1 mg cm⁻² (FIG. 3B) and 3.6-4 mg cm⁻² (FIG. 3C);

FIGS. 4A-4B are graphs showing: the electrochemical impedance spectrum (FIG. 4A) and the galvanic charge-discharge (FIG. 4B) of a CBAD-Sprayed single layer electrode PVDF pouch cell with an areal sulfur loading of 1.22 mg cm⁻² and an electrolyte to sulfur ratio of 18 μL mg⁻¹ subject to a 0.083 C rate. The single layer electrode tested in FIGS. 4A-4B comprises 65 wt. % sulfur, 25 wt. % carbon and 10 wt. % PVDF;

FIGS. 5A-5B are graphs showing: the electrochemical impedance spectrum (FIG. 5A) and the galvanic charge-discharge (FIG. 5B) of a CBAD-Sprayed single layer electrode PVDF pouch cell with an areal sulfur loading of 2 mg cm⁻² and an electrolyte to sulfur ratio of 15 μL mg⁻¹ subject to a 0.05 C rate. The single layer electrode tested in FIGS. 5A-5B comprises 65 wt. % sulfur, 25 wt. % carbon and 10 wt. % PVDF;

FIGS. 6A-6B are graphs showing: the electrochemical impedance spectrum (FIG. 6A) and the galvanic charge-discharge (FIG. 6B) of a CBAD-Sprayed single layer electrode PVDF pouch cell with an areal sulfur loading of 3.6 mg cm⁻² and an electrolyte to sulfur ratio of 15 μL mg⁻¹ subject to a 0.01 C rate. The single layer electrode tested in FIGS. 6A-6B comprises 65 wt. % sulfur, 25 wt. % carbon and 10 wt. % PVDF;

FIGS. 7A-7B are micrograms of the morphology of CBAD-Spray coated cathodes with 65 wt. % sulfur, 25 wt. % carbon and 10 wt. % LiPAA as a binder with ~1.6 mg cm⁻² (FIG. 7A) sulfur, and ~3-3.2 mg cm⁻² (FIG. 7B) sulfur.

FIGS. 8A-8B are graphs showing: the galvanic charge-discharge (FIG. 8A) and the specific capacity and coulombic efficiency as a function of cycle number (FIG. 8B) of a single layer LiPAA pouch cell with an areal sulfur loading of 1.6 mg cm⁻² and an electrolyte to sulfur ratio of 15 μL mg⁻¹ subject to a 0.1 C rate;

FIGS. 9A-9B are graphs showing: the galvanic charge-discharge (FIG. 9A) and the specific capacity and coulombic efficiency as a function of cycle number (FIG. 9B) of a single layer LiPAA pouch cell with an areal sulfur loading of 3.1 mg cm⁻² and an electrolyte to sulfur ratio of 15 μL mg⁻¹ subject a 0.05 C rate;

FIGS. 10A-10B are graphs showing: the electrochemical impedance spectrum (FIG. 6A) and the galvanic charge-discharge (FIG. 6B) of a single layer PVDF pouch cell with an areal sulfur loading of 2 mg cm⁻² and an electrolyte to sulfur ratio of 15 μL mg⁻¹ subject to a 0.05 C rate compared to the same measurements taken for a double layer LiPAA-PVDF pouch cell having a 2.5 mg cm⁻² sulfur areal loading and the same electrolyte to sulfur ratio;

FIGS. 11A-11B are graphs showing: the galvanic charge-discharge (FIG. 11A) and the specific capacity and coulombic efficiency as a function of cycle number (FIG. 11B) of a double layer LiPAA-PVDF pouch cell with an areal sulfur loading of 2.8 mg cm⁻² and an electrolyte to sulfur ratio of 10 μL mg⁻¹ subject to a 0.1 C rate;

FIG. 12A is a graph showing: the electrochemical impedance spectra of a single layer PVDF pouch cell with 3.6 mg cm⁻² of sulfur and 15 μL mg⁻¹ vs the electrochemical impedance spectra of a double layer LiPAA-PVDF pouch cell with 3.8 mg cm⁻² of sulfur and 15 μL mg⁻¹ (FIG. 12A). FIG. 12B is a galvanic charge-discharge graph of the single layer PVDF pouch cell described previously when subject to a 0.01 C rate vs. the galvanic charge-discharge graph of double layer LiPAA-PVDF pouch cell as described prior when subject to a 0.025 C rate. FIG. 12C is a graph showing the electrochemical performance at a 0.025 C rate after degassing;

FIG. 13A is an SEM image of an uncalendared triple layer LiPAA-PVDF-LiPAA cathode with an areal loading of 4 mg cm⁻² and a sulfur to electrolyte ratio of 10 μL mg⁻¹. FIG. 13B is a galvanic charge-discharge graph of a cell comprising the previously described cathode. FIG. 13C is a graph showing the cycle performance of the previously described cell;

FIG. 14A is an SEM image of an uncalendared quadruple layer LiPAA-PVDF-LiPAA-PVDF cathode with an areal loading of 3.5 mg cm⁻² and a sulfur to electrolyte ratio of 10 μL mg⁻¹. FIG. 14B is a galvanic charge-discharge graph of a cell comprising the previously described cathode. FIG. 14C is a graph showing the cycle performance of the previously described cell;

FIGS. 15A-15D are graphs of the electrochemical impedance spectra of a coin cell having a: 1-layer cathode (FIG. 15A); a 2-layer cathode (FIG. 15B); a 3-layer cathode (FIG. 15C); a four-layer cathode (FIG. 16D);

FIGS. 16A-16D are the cycle performance of the corresponding coin cells described in FIGS. 15A-15D;

FIGS. 17A-17C are graphs showing the electrochemical impedance spectra (FIG. 17A) of coin cells having an electrolyte to sulfur ratio of 10 μL mg⁻¹, the cycle performance of the same coin cells when subject to a 0.05 C rate discharge (FIG. 17B), and the galvanic charge-discharge when subject to the same discharge rate (FIG. 17C);

FIGS. 18A-18B are graphs showing the cycle performance of a coin cell with an electrolyte to sulfur ratio of 10 μL mg⁻¹ comprising: a 3-layer LiPAA-PVDF-LiPAA cathode with an areal sulfur loading of 4.4 mg cm⁻² (FIG. 18A); and a 4-layer LiPAA-PVDF-LiPAA-PVDF cathode with an areal sulfur loading of 4.9 mg cm⁻² (FIG. 18A); both of which were subject to a 0.05 C rate discharge;

FIG. 19 is a table showing the relevant information for 8 tested coin cell formats including the areal sulfur loading, number of interfaces between layers, per-layer areal sulfur loading and stable capacity;

FIGS. 20A-20D is a series of SEM images of one-layer (20A), two-layer (20B), three-layer (20C) and four-layer (20D) cathodes with sulfur areal loadings of 4.0±0.2 mg/cm²;

FIGS. 21A-21D is a series of cross-sections of one-layer (21A), two-layer (21B), three-layer (21C) and four-layer (21D) cathodes with sulfur areal loadings of 4.0±0.2 mg/cm².

FIG. 22 is a graph showing the cyclic voltammograms of each of the cathode architectures;

FIGS. 23A-23C are Tafel plots of the anodic process (23A) and the cathodic processes (23B and 23C); and

FIG. 24 is a graph from a galvanic intermittent titration technique test showing the voltage-time response during and immediately following discharge.

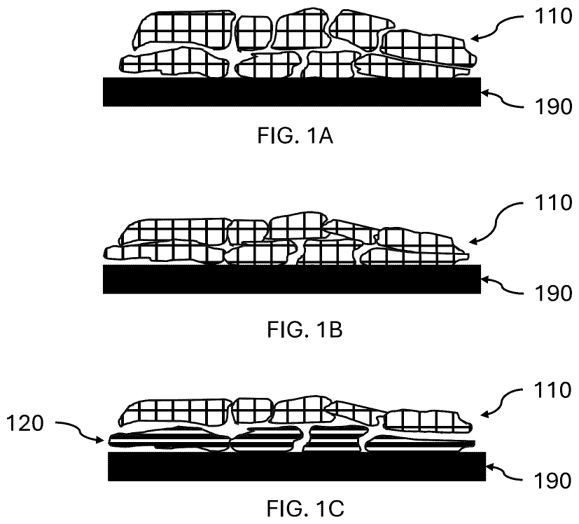

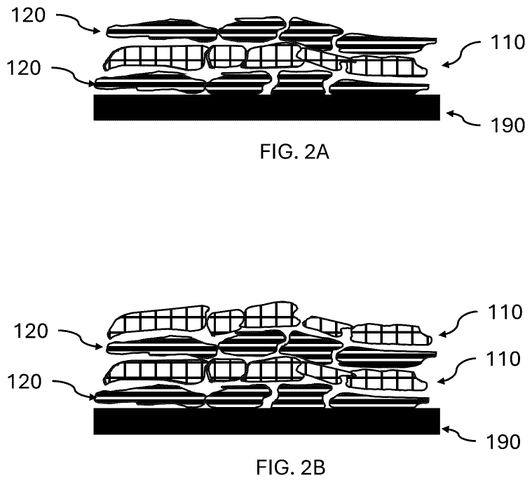

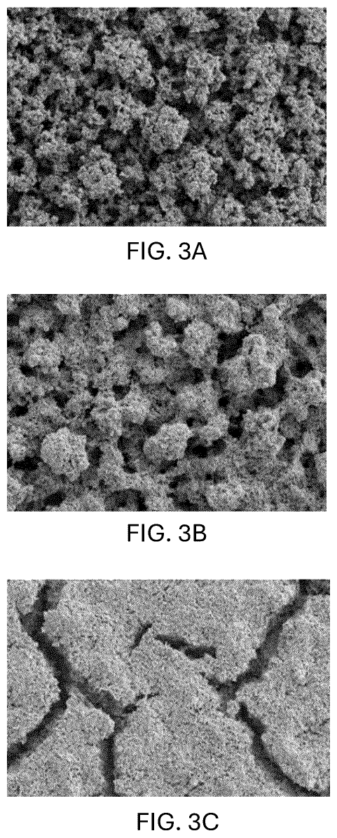

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

In general, the present disclosure is directed to multilayer electrodes and methods of fabricating multilayer electrodes. Without wishing to be limited, such a multilayer electrode may comprise a first and second electrode active layer. The multilayer electrodes as described herein may possess a variety of advantages, such as increased energy density, increased volumetric and gravimetric densities, increased cyclability and increased thermal stability. Several of the formerly mentioned advantages may be obtained as the presently described methods and multilayer electrodes formed therefrom may be used in combination with high areal loadings of electrode active materials, such as sulfur, such as greater than or equal to 3.5 mg cm⁻², as well as lower electrolyte to electrode active material ratios, such as less than or equal to 15 μL mg⁻¹.

In embodiments, the presently described multilayer electrodes comprises an a current collector, an electrode active stack disposed on the current collector, wherein the electrode active stack comprises a first electrode active layer disposed adjacent to the current collector and a second electrode active layer disposed adjacent to the first electrode layer. The multilayer electrode further comprises a first binder dispersed in the first electrode active layer and a second binder dispersed in the second electrode active layer. In embodiments, the multilayer electrode may comprise a number of electrode active layers greater than 2, such as between 2 and 40 layers, such as between 4 and 10 electrode active layers.

The method generally includes the step of forming multiple electrode slurries. The multiple electrode slurries may comprise an electrode active material, conductive material and a binder. A first electrode slurry may be differentiated from a second electrode slurry by the presence of a first and second binder. Thereafter, a current collector may be coated with the multiple electrode slurries in an alternating fashion, with sufficient time between coatings to allow each coated electrode slurry to dry. Furthermore, the present disclosure describes various multilayer electrodes and devices which incorporate said electrodes.

Without wishing to be bound to any particular theory, the present inventors have found that electrode slurries with high concentration of electrode active material may cause the resulting electrode to be impermeable to electrolytes, thereby leading to increased resistance and decreased capacity. When multiple layers of electrode are sprayed with the same slurry, the same issue may occur as the solvent in the new layer may re-wet the dried layer.

Various electrode active materials may be used. For instance, such electrode active materials may include, but are not limited to, sulfur, manganese, nickel, iron, lithium iron phosphate, lithium metal-doped iron phosphate, cobalt, lithium, titanium, allotropes of carbon such as graphite and graphene, silicon or mixtures thereof, and oxides, nitrides and phosphates thereof where applicable. In embodiments where lithium metal-doped iron phosphate may be used, the dopant, while not particularly limited, may comprise manganese, nickel, rhodium, ruthenium, cobalt, cobalt or mixtures thereof. Generally, however, it will be appreciated by one of skill in the art that the present method is not particularly limited by the composition of the electrode active material, as the present method enables a wide variety of electrode active materials to be used.

In some embodiments of the present disclosure, the electrode active material may comprise sulfur. In one embodiment, the sulfur electrode may include a sulfur-containing source. For instance, the sulfur-containing source may include, but is not limited to, sulfur particles in the form of a powder. In one embodiment, sulfur particles can be present in the electrode (or electrode layer) in an amount of from about 50% by weight to about 98% by weight, such as from about 55% by weight to about 75% by weight, such as from about 60% by weight to about 70% by weight, or any range therebetween. For instance, sulfur particles may be present in the electrode at a concentration of 70% by weight.

In some embodiments of the present disclosure, an electrode may have a specific areal loading of sulfur within the electrode. For example, the electrode may have an areal loading of electrode active material, such as, but not limited to, sulfur, greater than 2 mg cm⁻², such as greater than 3 mg cm⁻², such as greater than or equal to 3.5 mg cm⁻², such as greater than 4 mg cm⁻², such as greater than 4.5 mg cm⁻² of sulfur, such as greater than 5 mg cm⁻². In embodiments, the areal loading of sulfur within the multilayer electrode may be between 2 and 10 mg cm⁻², such as between 3.5 and 7 mg cm⁻², such as between 4 and 6 mg cm⁻².

In some embodiments of the present disclosure, the electrode active material, such as the cathode active material, may be a metal oxide intercalation active material as is known in the art, such as lithium nickel manganese cobalt oxide, lithium nickel oxide, lithium manganese oxide spinel and lithium cobalt oxide. The multilayer electrode, such as the cathode, in particular the electrode active layer, can include a metal oxide compound and an electrolyte/binder that can provide ionic transport or can include only the metal oxide intercalation material, as desired.

The metal oxide electrode active material can be prepared having a unit structure characterized by the ability to insert lithium-ion in an electrochemical reaction. Such compounds are referred to as intercalation compounds and include transition metal oxides having reversible lithium insertion ability. The transition metal of the electrode active material can include one or more of V, Co, Mn, Fe, and Ni.

In some embodiments of the present disclosure, the electrode active material can be pre-processed to prepare small-sized particles and de-agglomerating them before electrode fabrication. For instance, the electrode active material may range in size from about 1 μm to about 40 μm, such as from about 5 μm to about 35 μm, such as from about 10 μm to about 25 μm, or any range therebetween.

In some embodiments of the present disclosure, the electrode active material may be present at 50% wt. % to 98% wt. %, such as 55% wt. % to 75% wt. %, such as 60% wt. % to 70% wt. %, such as 70 wt. % or any range therebetween based on the weight of the electrode active layer.

In addition to the prior described materials, electrodes and/or electrode slurries and/or electrode layers as disclosed herein may comprise a conductive material. The conductive material may serve to increase the conductivity of the electrodes with respect to the current collector. For instance, the conductive material may comprise carbon, metal, alloys, or mixtures thereof.

In embodiments wherein the conductive material comprises carbon, the carbon particles may comprise carbon black, activated carbon, carbon nanotubes (e.g., multi-walled carbon nanotubes), carbon fibers, graphitized carbon, mesoporous carbon, or mixtures thereof. The utilization of the electrode active material can also be increased by increasing electronic conductivity through the utilization of carbons with higher surface areas, such as carbon black having a surface area greater than 1200 m² g⁻¹ as measured by BET.

In general, the conductive material is present in the electrode layer at a concentration of from about 1% to about 25% by weight, such as from about 5% by weight to about 22% by weight, such as from about 10% by weight to about 20% by weight, such as from about 12.5% by weight to about 15% by weight, or any range therebetween based on the weight of the electrode layer.

As described above, binders for use in the presently described electrodes and electrode layers include polyvinylidene fluoride and lithium polyacrylate. Further, the binders may comprise other binders known in the art, examples of which can include, without limitation, polytetrafluoroethylenes (PTFE), carboxymethyl cellulose (CMC), rubbers such as styrene butadiene rubber (SBR) and natural latex rubbers, polyacrylic acids (PAA), polyurethanes, ethylene vinyl acetates, polyacrylamides, starches, acrylonitrile copolymer, polyacrylonitrile, poly(vinylidene fluoride)-hexafluoropropene, polyvinyl alcohol, chitosan, sodium alginate or polyvinyl pyrrolidone. Furthermore, a blend or copolymer of binders may be utilized.

Binders are commonly used in electrodes, which are commonly formed from electrode active materials in a powdered form. Thus, the binder may serve to adhere the powdered materials into a single mass.

Polyvinylidene fluoride is a thermoplastic fluoropolymer which is typically unreactive given its high number of fluorinated carbons. Polyvinylidene fluoride may be used as a binder in lithium-ion batteries due to its thermal stability, resistance to oxidation low reactivity and lack of reactivity with solvents, particularly with the solvent often used for the electrolyte. Furthermore, polyvinylidene fluoride has good stability under high voltage, e.g., 0 to 5 volts Li/Li+. Polyvinylidene fluoride may have a molecular weight of between 500 kDa and 500,000 kDa, such as between 25,000 kDa and 300,000 kDa, such as between 75,000 kDa and 150,000 kDa. In some embodiments, the polyvinylidene fluoride may have a molecular weight of between 1000 kDa and 100,000 kDa. Furthermore, the polyvinylidene may be provided such that 40 wt. % of the total weight of polyvinylidene fluoride has a molecular weight greater than 75,000 kDa and less than 125,000 kDa, and the remaining 60 wt. % has a molecular weight less than 10,000 kDa and greater than 500 kDa.

Lithium polyacrylate is a lithiated polymer which may be used as a binder which can stabilize the electrode-electrolyte interface. Lithium polyacrylate binders as used herein may have a molecular weight of between 150 and 40,000 kDa, such as between 500 and 2,000 kDa, such as between 750 and 1,500 kDa. Furthermore, the lithium polyacrylate may be provided such that 40 wt. % of the total weight of lithium polyacrylate has a molecular weight greater than 10,000 kDa and less than 40,000 kDa, and the remaining 60 wt. % has a molecular weight less than 5,000 kDa and greater than 500 kDa. Lithium polyacrylate may have the structure as shown by chemical formula I below.

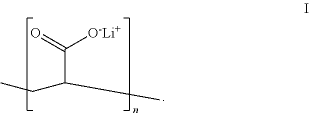

As stated above, other binders may be used. For instance, while LiPAA may be used as an example of a lithiated polymer, similar polymers may be used depending on the chemistry of the electrode desired. For instance, sodium polyacrylate may be used for sodium based batteries. Similarly, potassium, calcium and magnesium acrylate polymers may be used.

In embodiments, the electrode may comprise binders which are immiscible in each other. For instance, a liquid is immiscible in another liquid if its solubility is less than 1 g/100 mL. As a non-limiting example, binders which may be used may comprise polyvinylidene fluoride and lithium polyacrylate. However, one of skill in the art will appreciate that alternative pairs of immiscible binders may be used. Additionally, each of the immiscible binders may comprise a blend or a copolymer. That is, a blend or copolymer of polyvinylidene fluoride and styrene butadiene rubber may be used as a first binder, and a blend or copolymer of lithium polyacrylate and carboxymethyl cellulose may be used as a second binder.

The binder may be present in each electrode layer in an amount of from about 1% by weight to about 15% by weight, such as from about 2.5% by weight to about 12.5% by weight, such as from about 5% by weight to about 10% by weight, or any range therebetween based on the weight of the electrode layer.

Additionally, the multilayer electrode may comprise a current collector. Current collectors can be used in order to aid the flow of electrons from the electrode active material to the external circuit. The current collector may be formed of a sheet of a conductive material. For instance, the current collector may include, but is not limited to, aluminum, carbon paper, copper, nickel, titanium, stainless steel or alloys or mixtures thereof.

As also indicated herein, the present disclosure is directed to a method of making the multilayer electrode. In this regard, the method may comprise forming a first electrode slurry by mixing the electrode active material and the first binder to form a mixture. In some embodiments, a conductive material may be added to the mixture. In some embodiments, the mixture with or without the conductive material may be contacted with a solvent. A second electrode slurry may be formed by mixing the electrode active material and the second binder, adding a conductive material to the mixture, and contacting the mixture with a solvent to form the second electrode slurry.

The method of mixing the electrode active material with the binder, and optionally a conductive material is not particularly limited, but may comprise dry mixing in embodiments. For instance, the method as described in WO 2023/229728 A2, which is fully incorporated herein, may be utilized.

The solvents used in the first and second slurries may be different in order to solubilize the immiscible binders. For instance, a PVDF binder may be solubilized in NMP, whereas LiPAA is largely insoluble in NMP, requiring the use of alternative solvents, such as water. Thus, depending on the binder present in each slurry, a different solvent may be used. Solvents are not particularly limited, but include water, alcohols, ethers, esters, alkanes, alkenes, alkynes, amines, amides, or mixtures thereof. Further, the concentration of the solvent within the slurry may be used to affect the amount of electrode active material, conductive material, and binder is deposited in a single layer. Thus, one of skill in the art may prefer to use dilute electrode slurries in order to form thin individual layers.

After both of the first and second electrode slurries have been formed, a current collector may be coated by alternating between layers of the first and second electrode slurries. Thus, a current collector may be coated with a first layer of electrode slurry comprising the first electrode slurry. Thereafter, a second layer of electrode slurry comprising the second electrode slurry may be deposited onto the surface of the now-dried first electrode slurry on the current collector. In some embodiments, the second layer may be deposited after the first layer has dried. This process may be repeated, alternating between the first and second electrode slurries, for a large number of total layers, such as for a total number of layers between 2 and 40, such as between 4 and 10 layers. Additionally, in embodiments wherein the active electrode material comprises sulfur, each layer of the multilayer electrode may comprise between 0.7 and 1.6 mg cm⁻², such as between 0.9 and 1.4 mg cm⁻² of sulfur. Thus, for a two-layer multilayer electrode, a range of areal loadings between 1.8 and 2.8 mg cm⁻² may be achieved. While this range may serve as guidance, it is not intended that the range of 0.9 to 1.4 mg cm⁻² per layer be interpreted as a strict limitation of the present disclosure.

The electrode slurry may be coated onto the current collector by a variety of methods, including but not limited to, spray coating, doctor blading, slot die coating, gravure coating and screen printing. The method used to coat the electrode slurry during formation of an electrode can also be used to provide further improvement to the electrode.

For instance, in some embodiments, spraying involves layer-by-layer dispersion and deposition of a well-mixed electrode slurry onto the current collector. The spraying may be done using an airbrush. The layer can then be allowed to dry (e.g., at 100° C.) before another layer of slurry is sprayed and dried. The process can be repeated until the desired loading is achieved. Lastly, the electrode can be held under vacuum for 48 hours to ensure that all the solvent is removed. Spray coating can be used to form a highly porous electrode. It is also worth noting that when the spray-coated electrodes are formed, only a small amount of slurry is used in each step, and drying occurs almost instantly due to the heat and low overall volume of solvent per step. This means that the electrode is never really in a high liquid state (excess solvent) during its formation. Alternatively, using the conventional doctor blade technique can result in a denser electrode.

Alternatively, the coating method used to coat the current collector may be the doctor blade technique. In this embodiment, a current collector substrate can be placed onto a vacuum table in an enclosure to hold it in place. The homogeneous and well-mixed slurry can be placed onto the current collector. The blade can then be slowly moved along the substrate, spreading the slurry on the current collector to form a uniform thin layer. The electrode can then be dried, e.g., at room temperature. Because the layer can be dense and drying need not be aided with heat, the doctor blade electrodes can have longer drying times than the spray coated electrodes. During the doctor blade deposition, all of the slurry is spread on the current collector at once and drying occurs from a high liquid state.

In embodiments, the multilayer electrode may be subject to calendaring. Calendaring is the process of smoothing and compressing a material by passing the material through pairs of rollers which have a reduced thickness as compared to the thickness of the un-calendared material. In embodiments wherein the multilayer electrode is formed by spraying, calendaring may reduce the thickness of the electrode to between 10 and 20 percent of the original thickness, such as between 13 and 17 percent of the original thickness. To attain such a reduced thickness, a multilayer electrode may be subject to multiple calendaring treatments, such as between 3 and 6 calendaring treatments.

Thus, formed by the presently described process is a multilayer electrode characterized by having layers which contain alternating binders which are immiscible in one another.

The multilayer electrodes as described above may be part of an electrochemical cell. The electrochemical cells can provide high-energy density, high cycling rates (high power capability) and safe technology. The electrochemical cells can be used to form batteries that can meet existing challenges in battery technology. Moreover, the electrochemical cells can find immediate applications in electric vehicles, aerospace applications, and in renewable and grid energy storage, among others.

In one embodiment, the electrochemical cell may include an electrolyte. For instance, the electrolyte may include, but is not limited to, lithium bis(trifluoromethane) sulfonimide (LiTFSI), lithium hexafluorophosphate (LiPF₆), lithium nitrate, lithium perchlorate, lithium tetrafluoroborate, lithium bis(trifluoromethanesulfonyl)imide, lithium bis(oxalate) borate, lithium difluoro (oxalate) borate, or a combination thereof. Furthermore, the electrolyte may be dissolved in a solvent. In embodiments wherein the electrolyte comprises lithium or lithium-ions, the solvent of the electrolyte may comprise an organic solvent. For instance, the solvent may comprise 1,3-dioxolane (DOL), 1,2-dimethoxyethane (DME), carbonates such as ethylene carbonate (EC), diethyl carbonate (DC), dimethyl carbonate (DMC) and ethyl methyl carbonate (EMC), or mixtures thereof.

Furthermore, in some embodiments of the present disclosure, a first and second electrode comprising the cathode and anode of a battery may comprise first and second electrode active materials which are distinct. That is, the cathode may comprise sulfur, and the anode may comprise a mixture of silicon and graphite.

While some embodiments of the present disclosure are directed to, at least in part, lithium-based battery chemistries, it will be apparent to one of skill that the presently described multilayer electrodes may be used to fashion multilayer electrodes comprising battery chemistries other than lithium. For instance, alternate chemistries include, but are not limited to, sodium, potassium, calcium, magnesium or zinc ions.

In some embodiments of the present disclosure wherein the electrode active material comprises sulfur, the sulfur within an electrode layer may have a specific ratio with respect to the electrolyte. For instance, the electrochemical cell may have a sulfur to electrolyte ratio between 5 and 20 mg μL⁻¹, such as between 8 and 18 mg μL⁻¹, such as between 5 and 15 mg μL⁻¹, such as between 10 and 14 mg μL⁻¹.

Further, the electrochemical cell may comprise a separator. The separator is typically disposed between the first electrode and the second electrode, such as the anode and the cathode, and may have a very high resistance to current relative to the external circuit of the battery. However, the separator is permeable to ions generated during oxidation and reduction. This configuration therefore allows electrons to pass through the external circuit, typically used to power some device, while maintaining charge neutrality via the flow of ions through the separator. Said separator may comprise a polyolefin, such as polypropylene (PP), polyethylene (PE), copolymers thereof, ion exchange resins, or cellulose-derived materials. Commonly used in lithium-ion batteries are polypropylene separators. However, one of skill can envisage using copolymers or blended separators, for instance comprising polypropylene and polyethylene depending on the attributes of the separator which are sought.

In one embodiment, the electrochemical cell may be a battery as known in the art. A battery may include one or more of the cells sealed into a case according to standard methodology. For instance, the battery may be a lithium-sulfur battery. As a non-limiting example, the presently described electrodes comprising a crosslinked binder may be used as part of an electrochemical cell in a variety of form factors, such as a coin cell, pouch cell, prismatic cell or cylindrical cell.

The batteries as described herein may find a use in various applications, such as, but not limited to, mobile devices, electric vehicles, grid storage or home energy storage.

The present invention may be better understood with reference to the examples set forth below.

### Pouch Cell Examples

Pouch cells comprised 2×3 cm² cathodes and 2.1×3.1 cm² anodes. The cathodes were produced using the general method described above. Anodes comprised polished lithium. An aluminum tab was attached to the cathode, and a nickel tab was foam welded to the anode. The cathode and anode were then placed into a vacuum sealed to a pressure of −90 kPa. Pouch cells were subject to heating at 50 degrees Celsius for 20 hours prior to testing. Pouch cells were tested under a pressure of ~30 psi by placing the cells inside a metal clamp containing foam. After 3 cycles of charging-discharging, the pouch cells were degassed.

### Single Layer PVDF Pouch Cells

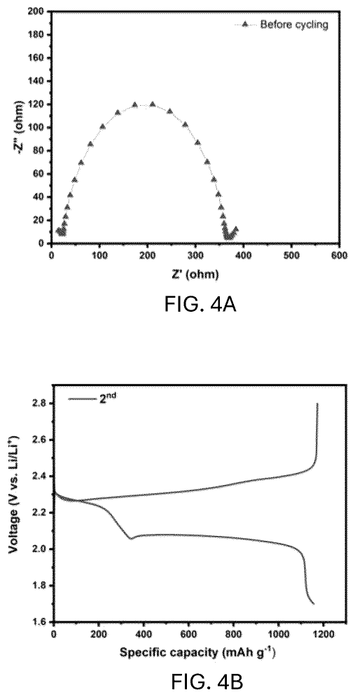

FIGS. 4A-4B show the electrochemical impedance spectra and galvanic charge-discharge graphs of a single layer PVDF pouch cell having an areal sulfur loading of 1.22 mg cm⁻², an electrolyte to sulfur ratio of 18 μL mg⁻¹ under a C rate of 0.083. Cathodes show good electrochemical performance at low areal sulfur loading of 1.3 mg cm⁻².

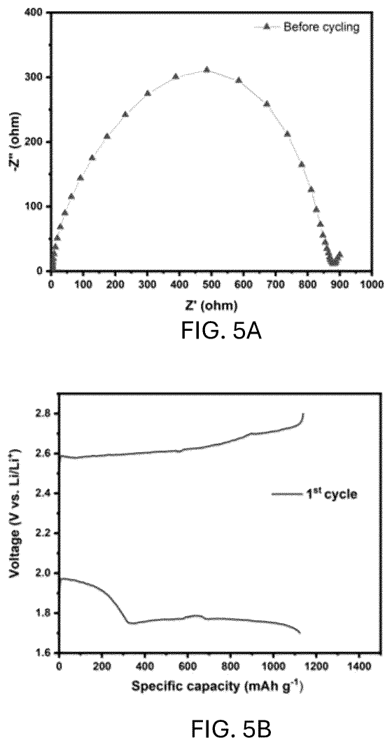

FIGS. 5A-5B show the electrochemical impedance spectra and galvanic charge-discharge graphs of a single layer PVDF pouch cell having an areal sulfur loading of 2 mg cm⁻², an electrolyte to sulfur ratio of 15 μL mg⁻¹ under a C rate of 0.05. Increasing the areal sulfur loading to 2 mg cm⁻², the cells failed to perform at 0.1 C-rate. However, it can be charge-discharge at lower current of 0.05 C-rate.

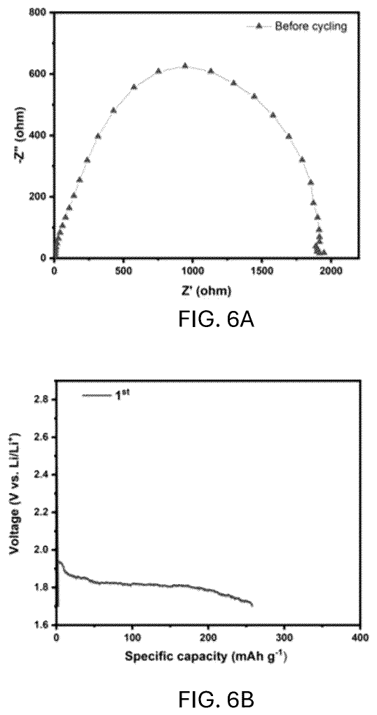

FIGS. 6A-6B show the electrochemical impedance spectra and galvanic charge-discharge graphs of a single layer PVDF pouch cell having an areal sulfur loading of 3.6 mg cm⁻², an electrolyte to sulfur ratio of 15 μL mg⁻¹ under a C rate of 0.01. On further increasing the areal sulfur loading to 3.6 mg cm⁻², the cell showed incomplete discharge and failure during charge even with very low current rates as low as 0.01 C.

### Single Layer LiPAA Pouch Cells

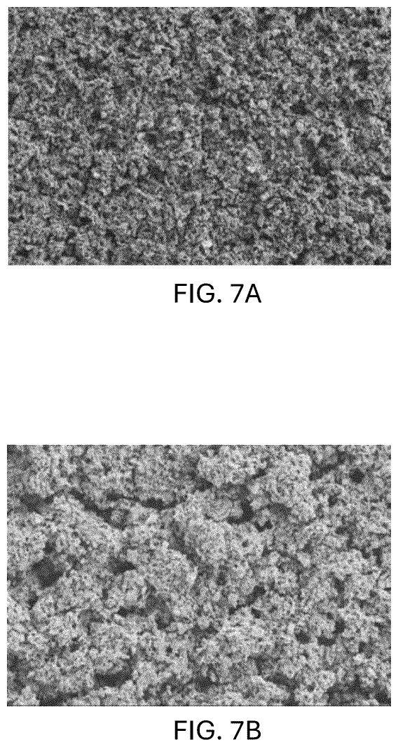

FIGS. 7A-7B show the morphologies of single layer LiPAA cathodes with ~1.6 mg cm⁻² (FIG. 7A) sulfur, and ~3-3.2 mg cm⁻² (FIG. 7B) sulfur.

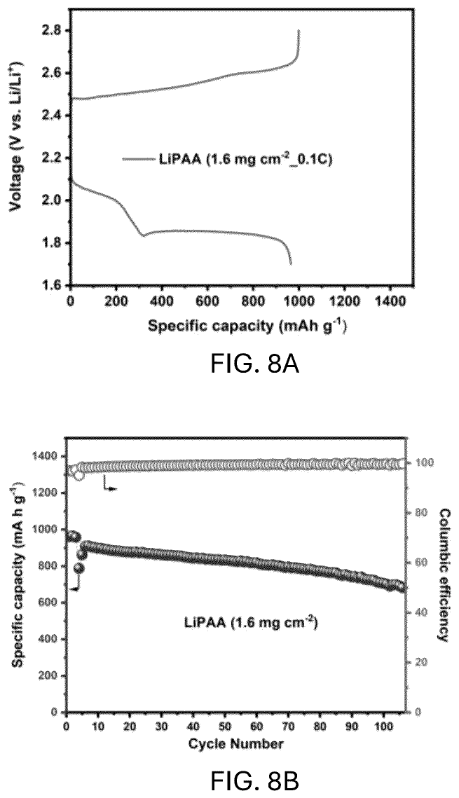

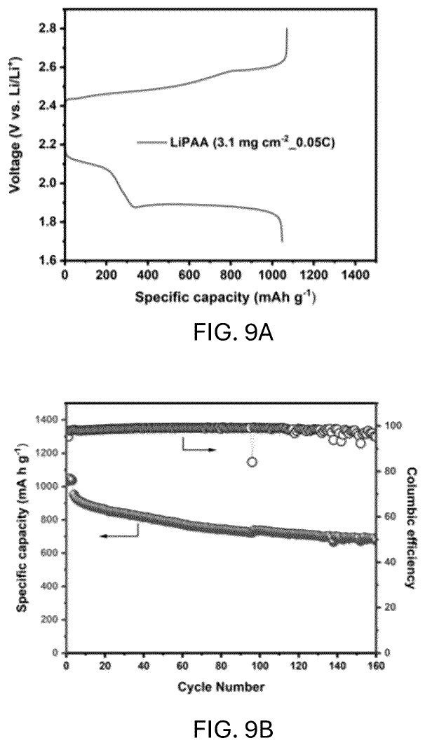

The cathodes shown in FIGS. 7A-7B were tested in pouch cells. As shown in FIGS. 8A-9B, cathodes show good electrochemical performance at low areal sulfur loading (1.6 mg cm⁻²). Increasing the areal sulfur loading necessitates the cells to perform at a lower current rate. The electrode cracking at a higher areal sulfur loadings didn't allow the cells to perform beyond ~3.1 mg cm⁻². The pouch cell tested in FIGS. 8A-8B was subject to discharge at a 0.1 C rate, whereas the pouch cell tested in FIGS. 9A-9B was subject to discharge at a 0.05 C rate. Both pouch cells had an electrolyte to sulfur ratio of 15 μL mg⁻¹.

### Double Layer LiPAA-PVDF Pouch Cells

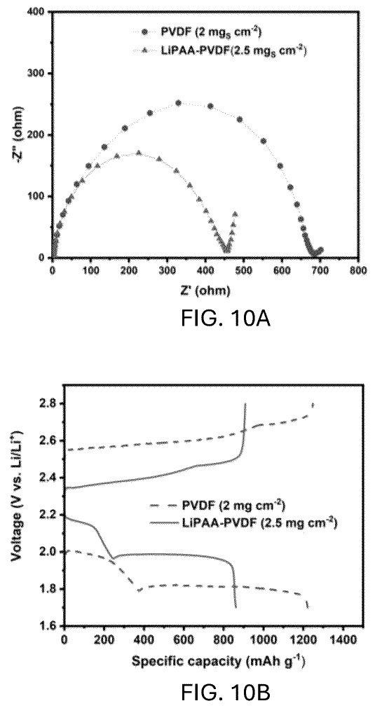

Shown in FIGS. 10A-10B is a pouch cell having LiPAA-PVDF double layer electrode with an areal sulfur loading of 2.5 mg cm⁻² and an electrolyte to sulfur ratio of 15 μL mg⁻¹. The pouch cell was subject to a 0.05 C rate current.

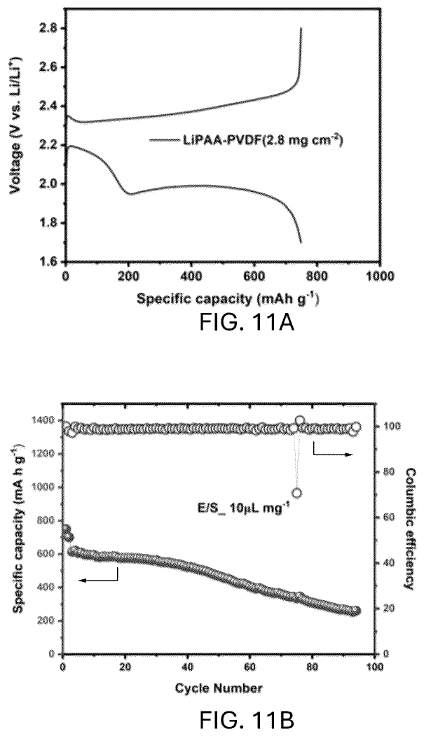

Shown in FIGS. 11A-11B is a pouch cell having LiPAA-PVDF double layer electrode with an areal sulfur loading of 2.8 mg cm⁻² and an electrolyte to sulfur ratio of 10 μL mg⁻¹. The pouch cell was subject to a 0.05 C rate current in FIG. 11A, and a 0.05 C rate current in FIG. 11B.

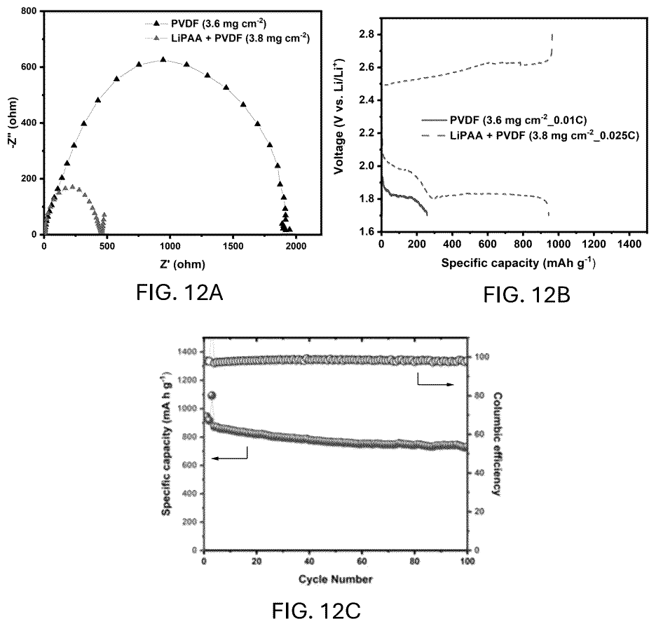

Shown in FIGS. 12A-12C is a pouch cell having LiPAA-PVDF double layer electrode with an areal sulfur loading of 3.8 mg cm⁻² and an electrolyte to sulfur ratio of 15 μL mg⁻¹. The pouch cell was subject to a 0.025 C rate current in FIGS. 12B-C. Double-layer cathodes performed at 0.025 C-rate. Whereas PVDF-based cathodes at high areal sulfur loading failed to perform even at 0.01 C-rate.

### Triple Layer LiPAA-PVDF-LiPAA Pouch Cells

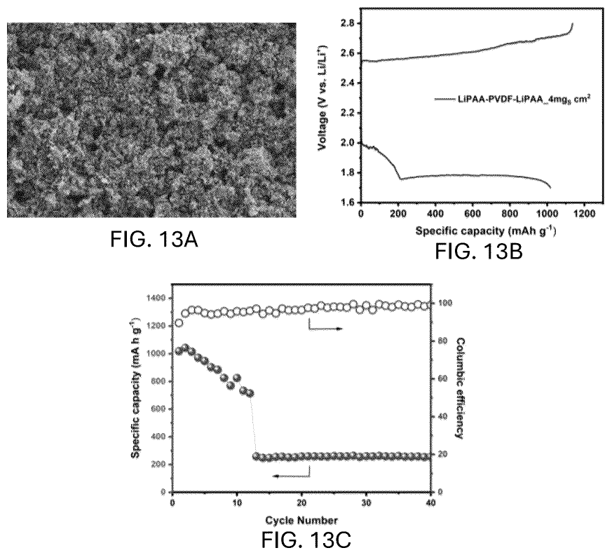

FIG. 13A is an SEM image showing the morphology of a triple layer cathode with an areal sulfur loading of 4 mg cm⁻². A pouch cell comprising the cathode shown in FIG. 13A, an electrolyte to sulfur ratio of 10 μL mg⁻¹ was subject to electrochemical impedance spectroscopy and cycle testing at a 0.025 C rate current, shown in FIGS. 13B-13C. After few cycles (~10 cycles), the cell hit the discharge cut-off voltage (1.7 V) before compete discharge due to high amount of polysulfide formation because of higher sulfur loading, and therefore, the capacity deteriorated; however, the cell remains functional.

### Quadruple Layer LiPAA-PVDF-LiPAA Pouch Cells

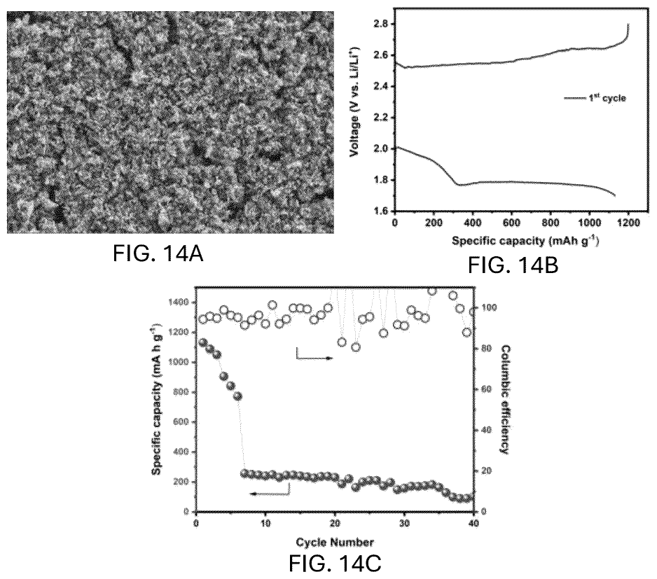

FIG. 14A is an SEM image showing the morphology of a quadruple layer cathode with an areal sulfur loading of 3.5 mg cm⁻². A pouch cell comprising the cathode shown in FIG. 14A, an electrolyte to sulfur ratio of 10 μL mg⁻¹ was subject to electrochemical impedance spectroscopy and cycle testing at a 0.025 C rate current, shown in FIGS. 14B-14C. The four-layer cathode showed a good charge-discharge performance at 0.025 C-rate, which indicates that multilayering approach helps to improve the electrochemical performance of Li—S pouch cell electrodes.

### Coin Cell Examples

Coin cells comprised 14 mm diameter cathodes and 16 mm diameter anodes. The cathodes were produced using the general method described above. Anodes comprised lithium foil. Coin cells were rested at room temperature for 5 hours prior to testing.

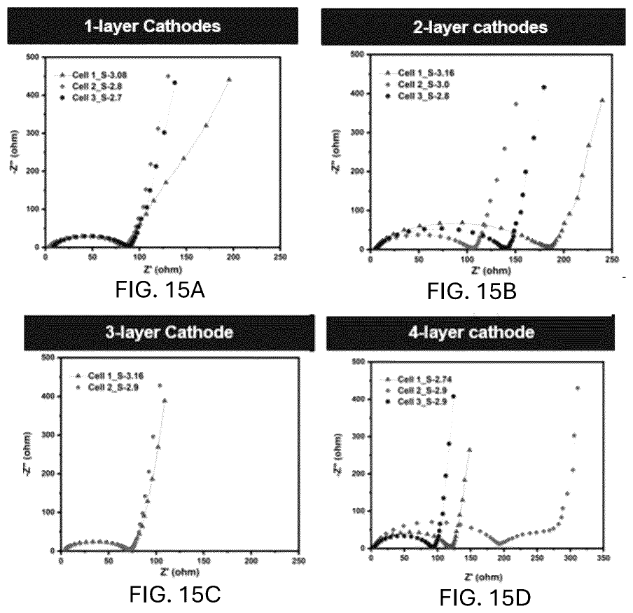

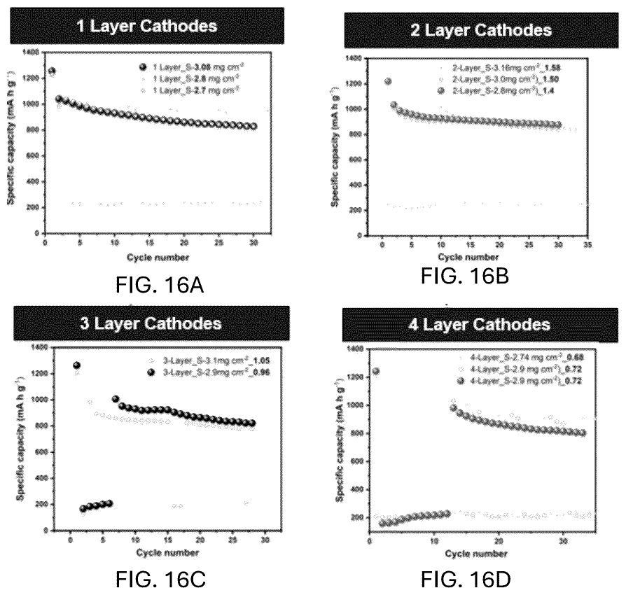

Test results for single layer cathode coin cells are shown in FIGS. 15A and 16A. Similarly, results for double layer, triple layer, and quadruple layer coin cells are shown in FIGS. 15B and 16B, 15C and 16C, 15D and 16D, respectively. The cells with very load and very high ratio of areal sulfur loading to number of interfaces (interfaces between layers e.g., double layer coin cell has one interface) show poor cycle performance and inconsistent capacity.

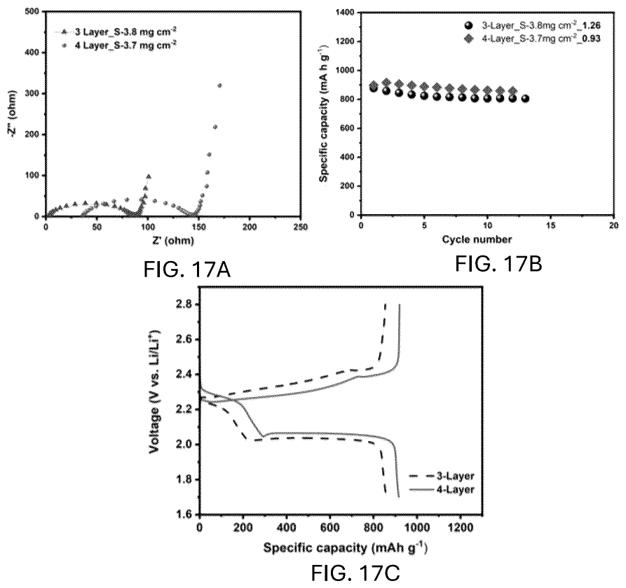

FIGS. 17A-17C show the electrochemical impedance spectra, cycle performance, and galvanic charge-discharge of both a triple layer and quadruple layer coin cell with sulfur areal loadings of 3.8 mg cm⁻² and electrolyte to sulfur ratios of 10 μL mg⁻¹. The resistance values for high areal sulfur loading cathodes showed a similar trend to that of cathode with medium sulfur areal loading. This indicates that the presence of PVDF in the upper layer may increase the charge-transfer resistance. The galvanic charge-discharge test was conducted after CV, thereby lowering the initial capacity values due to cell conditioning. As shown in FIGS. 17B and 17C, wherein the coin cells were subject to a 0.1 C rate current, the quadruple layer cathode shows significantly improved performance as compared to the triple layer cathode.

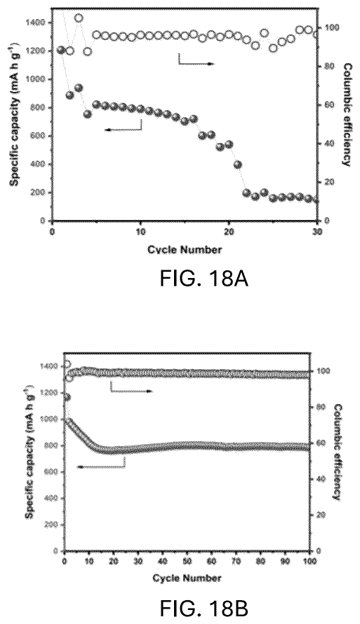

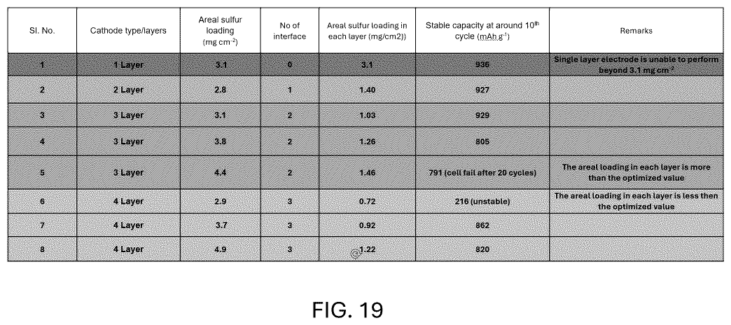

FIGS. 18A-18B show the cycle performance of a triple layer and quadruple layer coin cell with an electrolyte to sulfur ratio of 10 μL mg⁻¹ and areal sulfur loadings of 4.4 and 4.9 mg cm⁻² respectively. The cells in these tests were subject to a 0.05 C rate current. The coin cell with 3-layer cathode showed a gradual decrease in capacity over the cycling. The coin cell even at a higher areal sulfur loading of 4.9 mg/cm² showed high initial discharge capacity, and good cycle performance. In 4-layer cathodes, the effect of interfacial resistance is suppressed due to higher ratio of areal sulfur loading to number of layers.

FIG. 19 is a table summarizing the data discussed in the previously described examples.

### Electrochemical Assessments

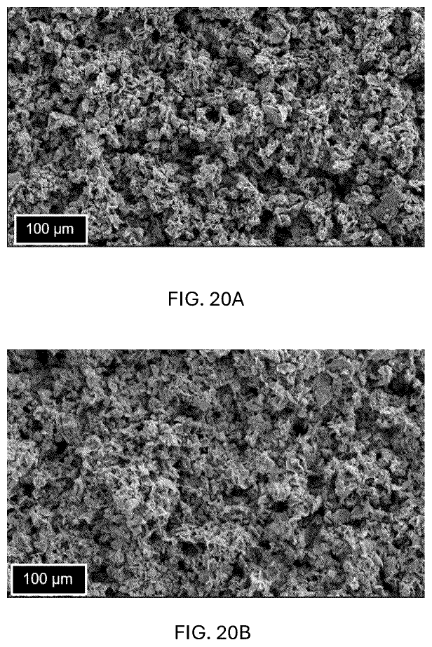

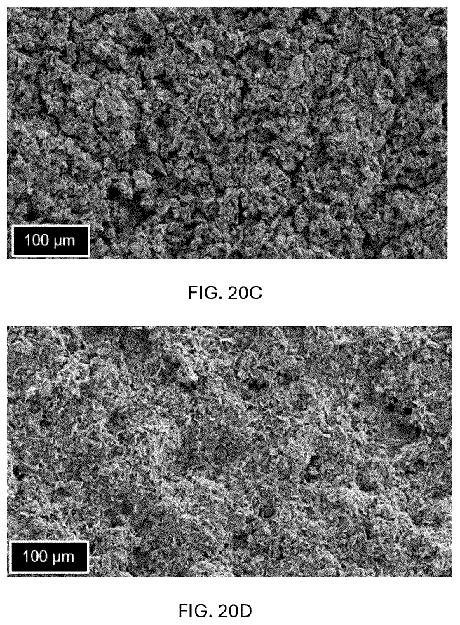

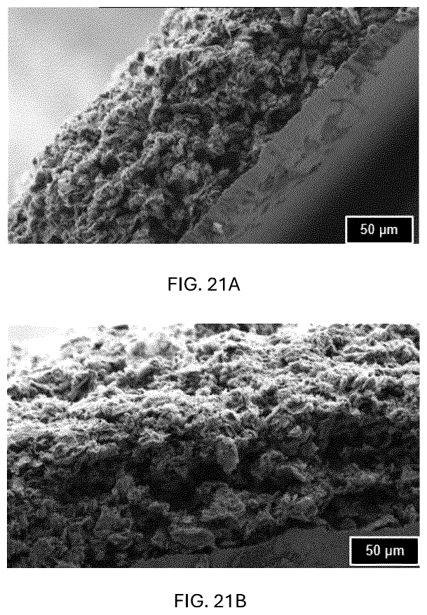

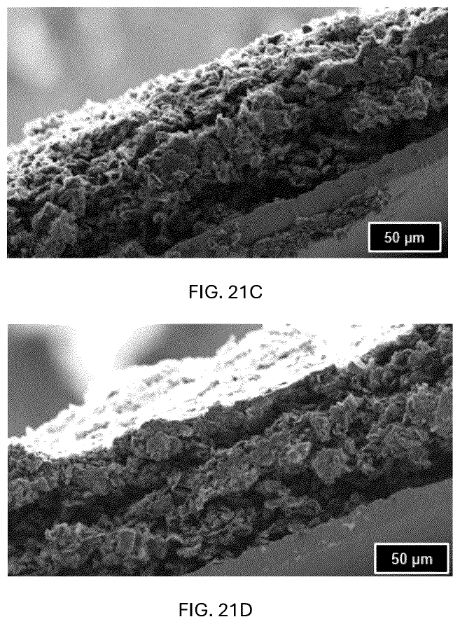

One, two, three and four layer cathodes were formed with 4.0±0.2 mg/cm² areal sulfur loadings (top surfaces pictured in FIGS. 20A, 20B, 20C and 20D, respectively, and cross-sections pictured in FIGS. 21A, 21B, 21C and 21D, respectively).

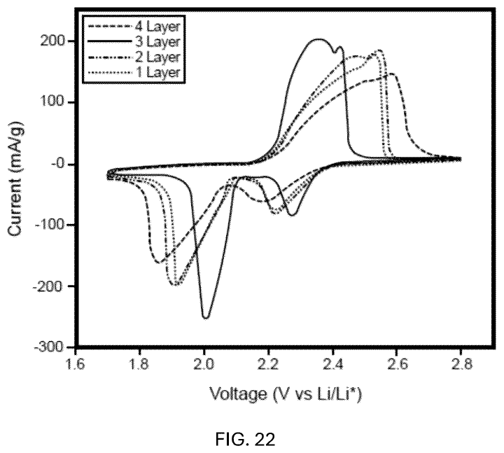

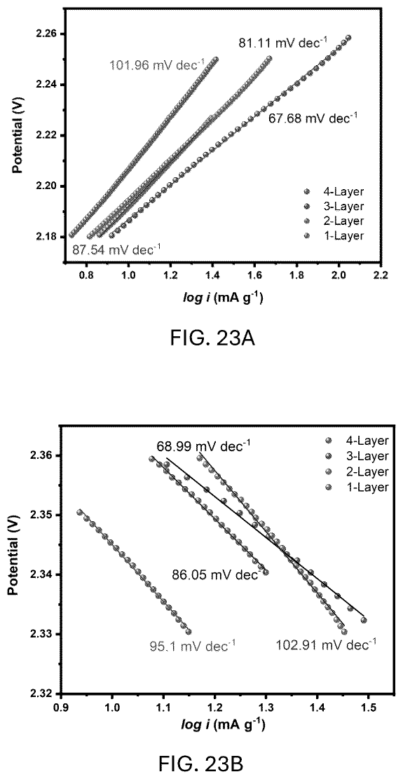

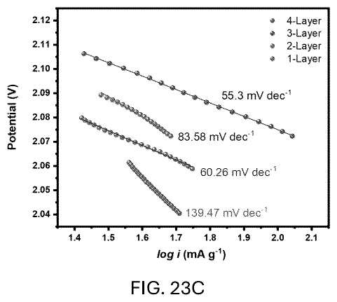

The four cathodes were subjected to cyclic voltammetry (shown in FIG. 22), and a series of Tafel plots were created for the anodic and cathodic processes (shown in FIGS. 23A, 23B and 23C.) The anodic process, shown in FIG. 23A, shows that the lowest overpotential required per decade of current was found in the three-layer architecture with an overpotential of 67.68 mV/dec, whereas the one-layer, two-layer, and four-layer architectures required overpotentials of 81.11 mV/dec, 87.54 mv/dec and 101.96 mv/dec, respectively. Further, the cathodic processes, shown in FIGS. 23B and 23C, show similar results, with the overpotential of the three-layer architecture in the C1 and C2 process being 68.99 mV/dec and 55.3 mV/dec, whereas the one-layer, two-layer and four-layer architectures in the C1 process required 86.05 mV/dec, 102.91 mV/dec and 95.1 mV/dec and required 83.58 mV/dec, 60.26 mV/dec and 139.47 mV/dec in the C2 process. Thus, collectively, FIGS. 23A-23C show that the three-layer architecture had the least overpotential of the four architectures.

The overpotentials were then deconvoluted, so as to examine which portions of the overpotential were due to ohmic losses, activation losses and concentration losses.

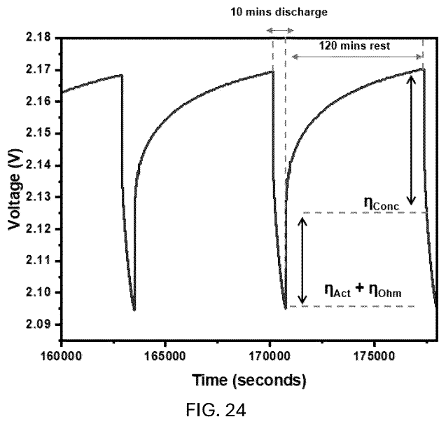

FIG. 24 is a graph resulting from a galvanic intermittent titration technique (GITT) test. In GITT, the cells were subjected to a 10-minute discharge at a 0.1C rate, followed by resting for 120 minutes. As can be seen from FIG. 24, immediately after the discharging was ceased, the voltage instantaneously increased due to the disappearance of the activation (η_{Act}) and ohmic (η_{Ohm}) overpotentials.

After the first 50 milliseconds of the rest period had passed, electrochemical impedance spectroscopy was performed for three minutes. The resistance was identified as the intercept on the real Z′ axis of the Nyquist plot, and ohmic overpotential was calculated using the below formula:

$${η}_{ohm} = I \times {R}_{ohm}$$

Further, after a 2-hour rest period, the concentration overpotential was determined by finding the voltage difference between the fully relaxed potential and the potential immediately after discharging in the GITT test, the results of which are shown below in Table 1.

TABLE 1
Deconvoluted overpotentials

| | | | |
|---|---|---|---|
| Architecture | Ohmic | Activation | Concentration |

| | | | | | | |
|---|---|---|---|---|---|---|
| 1 Layer | 3.893 | mV | 15.151 | mV | 153.502 | mV |
| 2 Layers | 4.677 | mV | 2.541 | mV | 85.516 | mV |
| 3 Layers | 3.513 | mV | 1.711 | mV | 71.757 | mV |
| 4 Layers | 3.051 | mV | 33.366 | mV | 250.384 | mV |

As can be seen above in Table 1, the ohmic overpotential was relatively constant for all the architectures. The activation overpotential was most significant in the one-layer and four-layer architectures. However, the dominant overpotential was the concentration overpotential, with the three-layer architecture exhibiting the lowest total and concentration overpotentials.

Additionally, the concentration overpotential of a single-layer architecture having sulfur areal loading of 1 mg/cm² was only 20 mV less than that of the three-layer architecture with a sulfur areal loading four times as large. Thus, the three-layer architecture possesses very high scaling efficiency when sulfur areal loadings are increased.

While certain embodiments of the disclosed subject matter have been described using specific terms, such description is for illustrative purposes only, and it is to be understood that changes and variations may be made without departing from the spirit or scope of the subject matter.

What is claimed is:

1. A multilayer electrode comprising:
a current collector;
an electrode active stack disposed on the current collector, the electrode active stack comprising a first electrode active layer disposed adjacent to the current collector and a second electrode active layer disposed adjacent to the first electrode active layer; and
a first binder dispersed in the first electrode active layer and a second binder dispersed in the second electrode active layer.

2. The multilayer electrode of claim 1, wherein the first electrode active layer and the second electrode active layer comprise an electrode active material comprising lithium nickel manganese cobalt oxide, lithium iron phosphate, lithium metal-doped iron phosphate, lithium nickel oxide, lithium manganese oxide spinel and lithium cobalt oxide, sulfur, lithium titanate, silicon, graphite, manganese, nickel, iron, cobalt or mixtures thereof.

3. The multilayer electrode of claim 1, wherein the first electrode active layer and the second electrode active layer comprises an electrode active material comprising sulfur.

4. The multilayer electrode of claim 1, wherein the multilayer electrode has an areal loading of sulfur of greater than or equal to 3.5 mg cm⁻².

5. The multilayer electrode of claim 1, wherein the first binder comprises a hydrophilic binder.

6. The multilayer electrode of claim 1, wherein the second binder comprises a hydrophobic binder.

7. The multilayer electrode of claim 1, wherein the electrode active stack comprises a third electrode active layer.

8. The multilayer electrode of claim 1, wherein the electrode active stack comprises a fourth electrode active layer.

9. The multilayer electrode of claim 1, wherein a battery comprises the multilayer electrode.

10. A battery comprising an anode, an electrolyte, a separator and a cathode, wherein the anode or cathode comprise an electrode active stack disposed on a current collector, the electrode active stack comprising a first electrode active layer disposed adjacent to the current collector and a second electrode active layer disposed adjacent to the first electrode layer; and
a first binder dispersed in the first electrode active layer and a second binder dispersed in the second electrode active layer.

11. The battery of claim 10, wherein the first electrode active layer and the second electrode active layer comprise an electrode active material comprising lithium nickel manganese cobalt oxide, lithium iron phosphate, lithium metal-doped iron phosphate, lithium nickel oxide, lithium manganese oxide spinel and lithium cobalt oxide, sulfur, titanium, silicon, graphite, manganese, nickel, iron, cobalt or mixtures thereof.

12. The battery of claim 10, wherein the first electrode active layer and the second electrode active layer comprises an electrode active material comprising sulfur and the battery has an electrolyte to sulfur ratio of less than or equal to 15 μL mg⁻¹.

13. The battery of claim 10, wherein the electrode stack has a sulfur areal loading of greater than or equal to 3.5 mg cm⁻².

14. A method for forming a multilayer electrode, the method comprising:
depositing a first electrode slurry on a current collector; and
depositing a second electrode slurry on the first electrode slurry, wherein the first electrode slurry comprises a first binder and the second electrode slurry comprises a second binder.

15. The method of claim 14, wherein the first and second electrode slurry comprise sulfur.

16. The method of claim 14, wherein the first electrode slurry and the second electrode slurry comprise an electrode active material comprising lithium nickel manganese cobalt oxide, lithium iron phosphate, lithium metal-doped iron phosphate, lithium nickel oxide, lithium manganese oxide spinel and lithium cobalt oxide, sulfur, titanium, silicon, graphite, manganese, nickel, iron, cobalt or mixtures thereof.

17. The method of claim 14, wherein the first electrode slurry is deposited on a surface of the current collector and is allowed to dry, forming a first electrode active layer.

18. The method of claim 17, wherein the first electrode active layer comprises sulfur.

19. The method of claim 18, wherein the first electrode active layer has a sulfur areal loading of greater than or equal to 3.5 mg cm⁻².

20. The method of claim 14, wherein the multilayer electrode is calendared.
